(19) United States
(12) Patent Application Publication
(10) Pub. No.: US 2011/0003503 A1
(43) Pub. Date: Jan. 6, 2011

(54) POWER SUPPLY WIRE RECEIVING STRUCTURE

(75) Inventor: Tsung-Hui Lin, Taipei (TW)

Correspondence Address: WPAT, PC;INTELLECTUAL PROPERTY ATTORNEYS, 2030 MAIN STREET, SUITE 1300, IRVINE, CA, 92614, US

(73) Assignee: SONICONN CO., LTD., Taipei City (TW)

(21) Appl. No.: 12/689,676

(22) Filed: Jan. 19, 2010

(30) Foreign Application Priority Data
Jul. 1, 2009 (TW) 098211971

(51) Int. Cl. H01R 13/72

(52) U.S. Cl. 439/501

(57) ABSTRACT

The present invention discloses a power supply wire receiving structure comprising a cable take-up unit and a charging wire. The charging wire is applicable to an electronic device and made of bullet-proof material so as to have high tensile strength. The charging wire is flat-shaped so that it is easy to be received in the cable take-up unit. The combination of the charging wire and the cable take-up unit enables the charging wire to be received in the cable take-up unit and facilitates the arrangement of the wire. Furthermore, the cable take-up unit can be coupled to a charging unit which has an accommodating groove so that the cable take-up unit is received in the accommodating groove of charging unit to reduce the product volume and be easy to carry.

### BACKGROUND OF THE INVENTION

(a) Field of the Invention The present invention relates to a power supply wire receiving structure, and more particularly to a power supply wire receiving structure capable of receiving a flat-shaped charging wire made of bullet-proof material.

(b) Description of the Prior Art

A charging wire is usually used to transmit electric power from a socket to an electronic device, for example, an electronic product such as a notebook computer, a cellular phone, a handheld digital device, etc., so as to supply electric energy to the electronic device or charge the rechargeable battery of the electronic device.

However, mostly in the manufacture of charging wires for common electronic devices, copper conductors are stranded with one another or parallel arranged and then coated with engineering plastic, such as heater parallel neoprene (HPN), service parallel thermoplastic (SPT), polyvinyl chloride (PVC), etc., to form insulating protection layers. Nevertheless, the charging wires produced in this manner have low tensile strength. They are easy to be broken after repeated insertion and extraction operations because the copper conductors yield to the stress or the insulating protection layers are bent and deformed by force, resulting in poor electrical conduction and failure in normal service, even the potential hazard of sparking and burning.

Furthermore, charging wires for common electronic devices are short of wire arrangement structures and need to be arranged and tied by rubber bands or belts with labor. It is inaesthetic and exposed wires increase the overall volume so that the charging wires are inconvenient to carry.

### SUMMARY OF THE INVENTION

In light of the aforementioned problems of the prior art, an object of the present invention is to provide a power supply wire receiving structure, so as to the problem that it is short of power supply wire receiving devices and not easy to arrange wires in the prior art.

According to the object of the present invention, there is provided a power supply wire receiving structure comprising a cable take-up unit and a charging wire for an electronic device. The charging wire for an electronic device is flat-shaped and received in the cable take-up unit.

The charging wire for an electronic device is made of bullet-proof material.

The charging wire for an electronic device has a connecting part that is round-shaped.

The connecting part has a hole.

As described above, the charging wire for an electronic device of the power supply wire receiving structure according to the present invention is flat-shaped so that it is easy to be received in the cable take-up unit to facilitate the arrangement of the wire. Moreover, the charging wire is made of bullet-proof material and thus has high tensile strength so that it can endure to be pulled and dragged repeatedly and not easy to be broken.

### BRIEF DESCRIPTION OF THE DRAWINGS

FIG. 1 is an assembly drawing of a first embodiment of the power supply wire receiving structure according to the present invention;

FIG. 2 is an exploded view of a first embodiment of the power supply wire receiving structure according to the present invention;

FIG. 3 is a schematic view showing the first action of a cable take-up unit of a first embodiment of the power supply wire receiving structure according to the present invention;

FIG. 4 is a schematic view showing the second action of a cable take-up unit of a first embodiment of the power supply wire receiving structure according to the present invention;

FIG. 5 is a schematic view showing the third action of a cable take-up unit of a first embodiment of the power supply wire receiving structure according to the present invention;

FIG. 6 is a schematic view showing the fourth action of a cable take-up unit of a first embodiment of the power supply wire receiving structure according to the present invention; and

FIG. 7 is an exploded view of a second embodiment of the power supply wire receiving structure according to the present invention.

### DETAILED DESCRIPTION OF THE PREFERRED EMBODIMENTS

Embodiments of the power supply wire receiving structure according to the present invention will be described hereinbelow with reference to the related drawings.

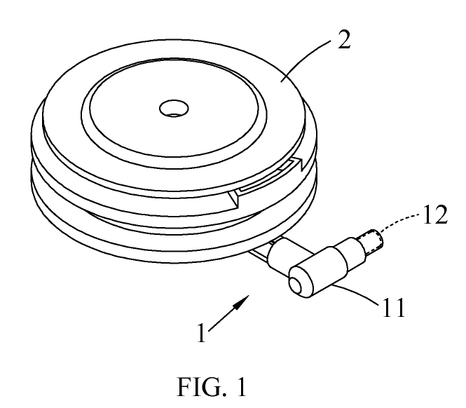

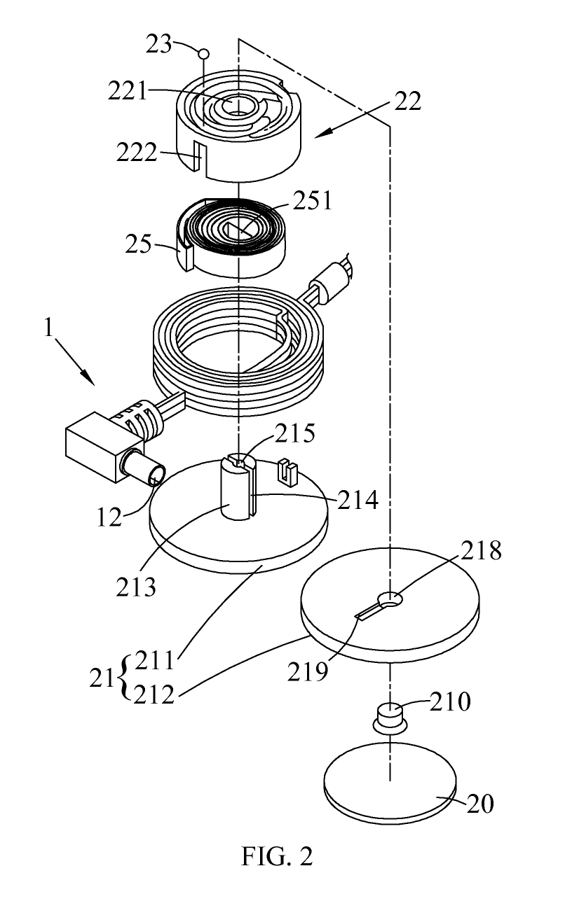

Referring to FIGS. 1 and 2, there are illustrated an assembly drawing and an exploded view of a first embodiment of the power supply wire receiving structure according to the present invention. In these figures, the power supply wire receiving structure comprises a cable take-up unit 2 and a charging wire 1.

The charging wire 1 can be made by twisting bullet-proof threads and copper conductors, followed by coating engineering plastic having an insulating effect, such as heater parallel neoprene (HPN), service parallel thermoplastic (SPT), polyvinyl chloride (PVC), etc. on the outer layer thereof. The bullet-proof material is a polyaromatic amide fiber (KELVAR), which has the features of low density and high strength and thus high tensile strength so that the charging wire can endure to be pulled and dragged repeatedly and not easy to be broken. Furthermore, in order to receive the charging wire 1 in the cable take-up unit 2, the shape of the charging wire 1 is designed as a flat shape for the convenience of drawing or winding. The charging wire 1 has at its one end a round-shaped connecting part 11 in which a hole 12 is recessed. The charging wire 1 can be electrically connected to an electronic device like a notebook computer, a handheld mobile device (such as a cellular phone), a navigation device, an audio/video player, etc., so as to supply electric energy to the electronic device or charge its rechargeable battery.

The cable take-up unit 2 may be a coiling drum, which is used to receive a charging wire for an electronic device and has a casing 21, a turning wheel 22, a ball 23 and a spiral spring 25.

The casing 21 comprises a first casing 211 and a second casing 212 and the charging wire 1 is accommodated in the first casing 211 and the second casing 212. A shaft post 213 protrudes from the central portion of the first casing 211 and is provided with a split groove 214 such that the spiral spring 25 and the turning wheel 22 are sequentially disposed thereon. The upper end part of the split groove 214 is formed with a screw hole 215. A through hole 218 is provided on the central portion of the inner surface of the second casing 212 such that a screwing element 210 passes therethrough and is screwed into the screw hole 215 of the first casing 211. The second casing 212 has a position limiting slot 219 recessed on one side of the through hole 218 and the position limiting slot 219 can be formed in a stripe shape. Furthermore, a cover plate 20 is attached to the surface of the second casing 212. The first casing 211 and the second casing 212 can mutually engage with the shaft post 213 and the through hole 218.

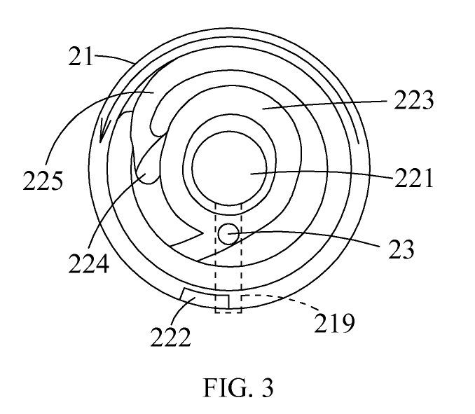

Also referring to both FIGS. 2 and 3, a locating hole 221 is provided on the turning wheel 22. The locating hole 221 is hollow and disposed around the shaft post 213 of the first casing 211. The turning wheel 22 has two slots 222 located on the circumferential face of the turning wheel 22. Furthermore, a groove 223 is annularly disposed on the turning wheel 22. Furthermore, a curved trench 225 is circumferentially disposed over a portion adjacent to the groove 223 and is adjacent to the end portion of the groove 223. The turning wheel 22 can be rotated clockwise or counterclockwise by the driving of the charging wire 1.

The ball 23 can be made of metallic material and be movably mounted on the surface of the turning wheel 22. When the first casing 211 engages with the second casing 212, the ball 23 is just located at the position of the groove 223 of the turning wheel 22 corresponding to the position limiting slot 219 of the second casing 212.

The spiral spring 25 is accommodated within the turning wheel 22, and the locking portion 251 on its inner side is connected to the split groove 214 of the shaft post 213 of the first casing 211.

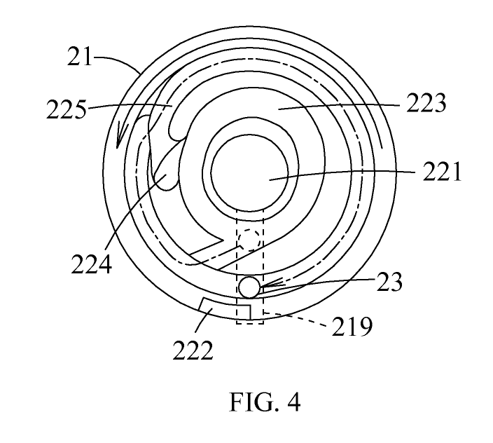

Referring to FIGS. 3 and 4, there are illustrated schematic views respectively showing the first action and the second action of a cable take-up unit of a first embodiment of the power supply wire receiving structure according to the present invention. When the charging wire 1 is pulled out to rotate the turning wheel 22 in a counterclockwise direction, the ball 23 in the groove 223 will rotate clockwise toward the curved trench 225 and be stopped at a desired position at an appropriate time. If it is desired to continue drawing of the wire, it only needs to pull the charging wire 1 slightly to a predetermined length and then release it. At this time, the ball 23 rolls clockwise due to the elastic deformation of the spiral spring 25. The ball 23 is positioned after it has moved toward and been caught by the guide channel 224. Therefore, the user can pull the charging wire 1 to a desired length, and then the wire will be temporarily held at this length and not be automatically wound. If the user continues to pull the charging wire 1, the ball 23 is caught by the guide channel 224 no longer so as to permit the turning wheel 22 to rotate in a counterclockwise direction so that the ball 23 in the guide channel 224 moves toward the groove 223 and rotates clockwise.

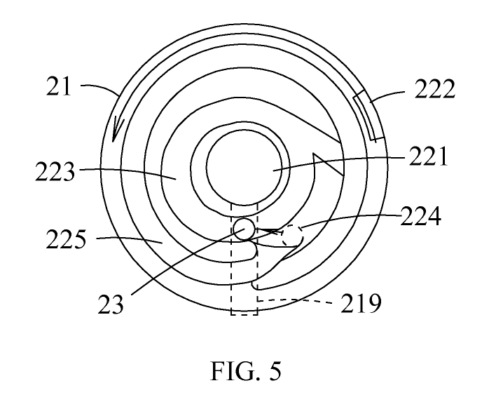

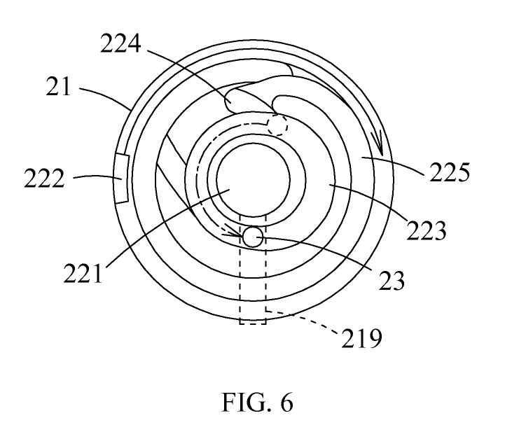

Referring to FIGS. 5 and 6, there are illustrated schematic views respectively showing the third action and the fourth action of a cable take-up unit of a first embodiment of the power supply wire receiving structure according to the present invention. When the user desires to wind the charging wire 1, it only needs to pull the charging wire 1 slightly to another predetermined length so as to permit the ball 23 to move from the guide channel 224 to the groove 223 and then release the charging wire 1 so as to permit the turning wheel 22 to rotate in a clockwise direction by the action of the spiral spring 25. In this manner, the charging wire 1 is retracted so that the wire cannot be seen by appearance to provide an aesthetic effect. Furthermore, the charging wire 1 is flat-shaped so it is easy to be pulled and rewound. Moreover, the charging wire 1 is made of bullet-proof material so as to avoid the breaking of the charging wire 1 caused by excessively frequent pulling and rewinding of the wire, or excessive pull force.

When the charging wire 1 is pulled out to a predetermined length every time, the catching structure of the cable take-up unit 2 can provide a stagewise non-return catching function so that the charging wire is temporarily held at this length for use. Moreover, when the charging wire 1 is pulled out to another predetermined length, the catching mechanism is automatically released and the charging wire can be automatically rewound so as to pull or wind the charging wire 1.

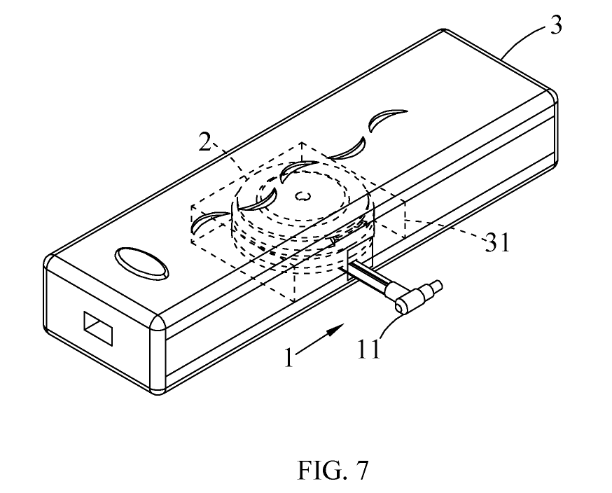

Referring to FIG. 7, there is illustrated an exploded view of a second embodiment of the power supply wire receiving structure according to the present invention. In this embodiment, the power supply wire receiving structure comprises a charging unit 3, a cable take-up unit 2 and a charging wire 1. The cable take-up unit 2 and the charging wire 1 are the same as those in the embodiment described above and will be explained in no more detail. The difference between this embodiment and the embodiment described above is that the charging unit 3 can be provided with an accommodating groove 31 in which the cable take-up unit 2 is received. The charging unit 3 is electrically connected to the charging wire 1. When the charging wire 1 is received in the cable take-up unit 2, no more exposed charging wire 1 can be seen by appearance. Not only does it look more aesthetic, but the overall volume can also be reduced and easy to carry. When the user desires to charge an electronic device, it only needs to pull and electrically connect the connecting part 11 of the charging wire exposed outside the charging unit 3 to the electronic device so as to supply electric energy to the electronic device for the convenience of operation or charge the electronic device for the convenience of outdoor use.

In summarization of the foregoing description, the effect of the power supply wire receiving structure according to the present invention is that the flat-shaped charging wire made of bullet-proof material is provided in the cable take-up unit so that it is not only easy to pull and rewind the wire but the wire also has high tensile strength and is not easy to be broken.

Another effect of the power supply wire receiving structure according to the present invention is that the cable take-up unit can be built in the charging unit so that it is convenient for the user to carry the charging unit.

The above description is illustrative only and is not to be considered limiting. Various modifications or changes can be made without departing from the spirit and scope of the invention. All such equivalent modifications and changes shall be included within the scope of the appended claims.

What is claimed is:

1. A power supply wire receiving structure comprising:
a cable take-up unit; and
a charging wire applicable to an electronic device, wherein said charging wire is received in the cable take-up unit being flat-shaped and made of bullet-proof material.

2. The power supply wire receiving structure as claimed in claim 1, wherein said charging wire has a connecting part that is round-shaped.

3. The power supply wire receiving structure as claimed in claim 2, wherein said connecting part has a hole.

4. The power supply wire receiving structure as claimed in claim 1, further comprising a charging unit in which said cable take-up unit is accommodated.

5. The power supply wire receiving structure as claimed in claim 1, wherein said cable take-up unit has a first casing and a second casing and said charging wire is accommodated in said first casing and said second casing.

6. The power supply wire receiving structure as claimed in claim 5, wherein said second casing has a position limiting slot recessed in the inner surface thereof.

7. The power supply wire receiving structure as claimed in claim 6, wherein a shaft post is disposed on said first casing and said shaft post is pivotally disposed to a turning wheel.

8. The power supply wire receiving structure as claimed in claim 7, wherein said turning wheel has a slot located on said circumferential face of said turning wheel for the installation of said charging wire.

9. The power supply wire receiving structure as claimed in claim 8, wherein a groove is annularly disposed on said turning wheel.

10. The power supply wire receiving structure as claimed in claim 9, wherein said shaft post is provided with a split groove for the connection of a spiral spring.

11. The power supply wire receiving structure as claimed in claim 10, wherein said turning wheel has a ball disposed on its surface and said ball is located at said position of said groove corresponding to said position limiting slot when said first casing and said second casing engage with each other.

12. The power supply wire receiving structure as claimed in claim 1, wherein the electronic device is a notebook computer or a handheld mobile device.
